(19) United States
(12) Patent Application Publication
(10) Pub. No.: US 2002/0005902 A1
(43) Pub. Date: Jan. 17, 2002

(54) Automatic video recording system using wide-and narrow-field cameras

(76) Inventor: Henry C. Yuen, Pasadena, CA (US)

Correspondence Address: Gifford, Krass, Groh, 280 N. Old Woodward Ave., Suite 400, Birmingham, MI, 48009, US

(21) Appl. No.: 09/872,884

(22) Filed: Jun. 1, 2001

Related U.S. Application Data
(60) Provisional application No. 60/209,116, filed on Jun. 2, 2000.

(51) Int. Cl. H04N 5/225

(52) U.S. Cl. 348/211; 348/169

(57) ABSTRACT

A system facilitates the automatic video recording of events which include a moving target. The invention is applicable to all types of videos, but sporting videos are particularly appropriate, where the moving target might be a ball, player, or other target. Broadly, the invention deploys at least two cameras, one (master camera) operating in wide-angle mode to cover a large field of view or the entire scene. At least one second camera operates in a pan/tilt/zoom-in mode relative to the master. A computer analyzes the video input from the first camera and “tracks” the target, preferably using image recognition. The coordinates of the tracked target are transmitted to the second computer to control the second camera(s) to record the event at close-up angles.

### REFERENCE TO RELATED APPLICATION

This application claims priority from U.S. provisional patent application Ser. No. 60/209,116, filed Jun. 2, 2000, the entire contents of which are incorporated herein by reference.

### FIELD OF THE INVENTION

This invention relates generally to video recording and, in particular, a system wherein multiple cameras are used to automatically record sports events and other programming.

### BACKGROUND OF THE INVENTION

The demand for video content will increase with the increase in bandwidth and the number of television channels. One of the cost items in the production of video content is the camera crew. In fact, for sports events, this can be the major cost item.

There are several patents directed to video production automation, but none include teachings which extend to truly unattended recording. Many of these inventions have to do with the focusing of multiple cameras. U.S. Pat. No. 4,581,647, for example, discloses a computerized control system for automatically focusing television cameras used for televising a sporting, or other events. The system includes a digitizing tablet on which an observer follows the action by moving a stylus continuously or from point-to-point across the plane surface of the tablet. The resulting digital signals generated by the tablet are fed to a computer in which they are converted to digital focusing signals which are fed to the television cameras. The computer is programmed so that it generates a different set of focus control digital signals for each camera as determined by the actual location of the individual cameras around the playing area. The digital focusing signals are converted to analog signals at each camera, and the analog signals are used at the individual cameras to activate a servo motor which controls the focus of the camera. Then, as each camera is panned and/or zoomed to follow the action, it is automatically maintained in focus. In a second embodiment, the digitizing tablet is transparent, and the operator observes the action on the playing area through the digitizing tablet.

U.S. Pat. No. 5,912,700 resides in a system for enhancing the television presentation of an object at a sporting event. The system, roughly described, determines an object's location, captures a video image which includes a field of view encompassing the location of the object, determines the position of the object in the field of view of the broadcast camera capturing the video image and enhances the television presentation of the object. One embodiment includes one or more sensors used to detect the object. A processor communicates with the sensors and is programmed to determine the object's position in the video image from the broadcast camera. If the sensor or the broadcast camera can be moved, the system includes one or more field of view sensors which provide the processor with information about the broadcast camera's (and the sensor's) field of view. A field of view sensor can include one or more of the following: a pan sensor, tilt sensor, zoom sensor, beacon or anything else used to determine the field of view of a camera or sensor. If the processor knows the three-dimensional location of the object, the processor can determine the position of the object in a video frame of any broadcast camera whose field of view is known.

U.S. Pat. No. 6,233,007 discloses a method and apparatus for tracking moving objects, particularly balls, pucks, and like used in sporting activities, to obtain information corresponding to the object being tracked. In one aspect of the present invention, such information is usable in a computer-generated replay of the sporting event (or some part thereof) using computer generated characters moving in accordance with motion data collected from real time tracking of the sporting event. The invention is intended to be especially useful for enhancing television coverage of sporting events. The apparatus includes at least one camera connected to a computer which operates to difference previous and current frames, compute the ball track, convert ball regions to HSV color space and output the tracking and video information. In a case where one or more pairs of cameras are used, the computer is preferably also provided with a stereo matching device or module for matching the tracking results from respective cameras and/or respective pairs of cameras.

U.S. Pat. No. 5,363,297 resides in a system for the accumulation of detailed moment-to-moment information concerning the movements of players and of the ball in a sporting contest. One or more cameras are situated so as to cover the entire playing area of the event. The output of at least one of these cameras is provided to a digital image processor, which tracks the movements of the images, or silhouettes, of players in the camera images. By employing multiple camera views of the same playing area, the tracking processor can, in most cases, resolve ambiguities arising from overlaps in any one view. For the remaining, unresolved, cases, one or more human operators, provided with the same or similar camera views, are employed, through an interactive interface. The operators are provided with apparatus for identifying players, through a query/response method, as requested by the tracking processor. The operators also provide initial player identification at the start of the event, and following breaks in the action, using the same apparatus. A variant system is described wherein the player identification task of the operator is performed, instead, by electronic tracking devices, such as radio transmitters, in conjunction with off-field electronics incorporating telemetry and triangulation in order to obtain identity and approximate position of all game participants.

Thus, although there are several patents directed to video production automation, none provide apparatus or methods for unattended automatic video recording of a sporting event or other show.

### SUMMARY OF THE INVENTION

This invention facilitates the automatic, preferably unattended recording of events which include a moving target. It is applicable to all types of videos, but sporting videos are particularly appropriate, where the moving target might be a ball, player, or other target.

Broadly, the invention deploys at least two cameras, one (master camera) operating wide angle mode which covers a large field of view or the entire scene. The second camera (as well as a host of other cameras, if they are also employed) operates in a zoom-in mode (relative to the first).

A computer analyzes the video input from the first camera and “tracks” the target, preferably using image recognition. The coordinates of the tracked target are transmitted to the second computer to control the second camera, acting as a slave camera, to record the event at close-up angles.

### BRIEF DESCRIPTION OF THE DRAWING

FIG. 1 is a drawing which depicts an application of the invention.

### DETAILED DESCRIPTION OF THE INVENTION

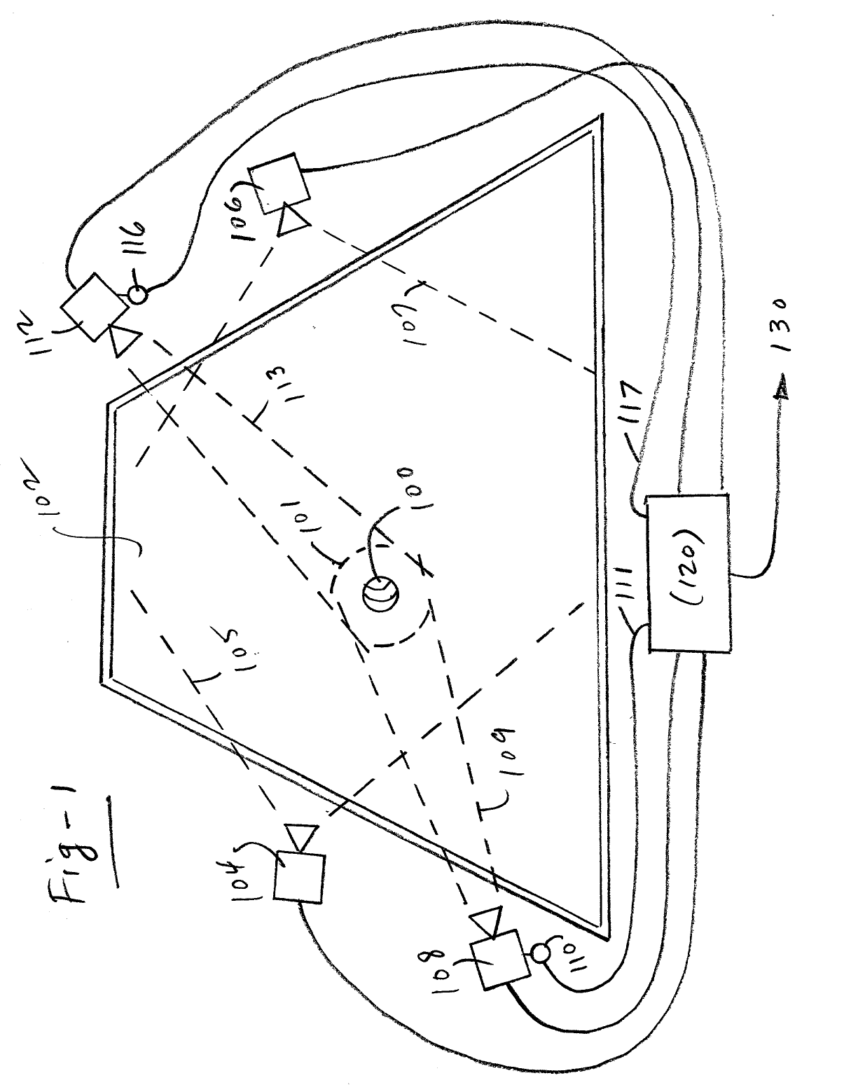

Reference is made to FIG. 1, which shows the applicability of the invention to a sports event, wherein a moving target is a ball 100 on a field 102. The system uses at least one wide-angle camera, such as camera 104 having a field-of-view 105, which includes some or all of the field 102. The camera may, or may not, have pan/tilt or zoom capabilities, and need not include such capabilities if the field of view and resolution are sufficient to follow the target 100 as it moves from place to place on the field 102. The invention is not limited to one such wide-angle “master” camera, as additional cameras such as 106 having field of view 107 may be added to increase the ability of determining the target 100 in three-dimensional space.

The system further includes at least one movable camera such as 108, on a pan/tilt mount 110 controlled along path 111 by processor 120. The camera 108 includes a narrower field-of-view as compared to the wide-angle camera(s), and automatic zoom/focusing capabilities, which may be controlled by processor 120, to follow the target 100 in close-up fashion. Again, the invention is not limited to one narrower field-of-view camera, as others such as 112, on pan/tilt mount 116 controlled by path 117, may be included for additional perspectives.

The outputs of each wide-angle master camera are used to determine the position of the target in free space, preferably using image processing/recognition techniques. Any known or yet-to-be-development pattern-recognition software may be used for such purposes, including those disclosed in U.S. Pat. No. 5,912,700 or 6,233,007, the entire contents of both being incorporated herein by reference. The outputs of each wide-angle camera are fed to the processor 120, which is programmed with the image/pattern recognition software to determine the target in free space. Based upon the position as determined, the pan/tilt and zoom functions of the narrower field-of-view cameras are controlled to track the target 100 as it moves in the field 102, providing details at a closer perspective. Although the fields of view 109 and 113 may be adjustable, at least with respect to a sporting event, it is preferred that they include not only the targets such as ball 100, but an area 101 surrounding the target, which may include players interacting with the ball, and so forth.

Based upon the inputs received from the various cameras, the processor 120 outputs a signal along path 130, which may be used for recording or broadcasting purposes. Although item 120 is referred to as “a processor,” it will be appreciated by those of skill in the art that the system 120 may include various processors, each controlled with proprietary or commercially available software to perform the various functions required herein.

In terms of alternative embodiments, the system just described may be extended in various ways. For one, it will be appreciated that more than one object may be tracked. The program used to analyze the tracked and untracked objects may be carried out in accordance with certain rules to further control the slave cameras (zoom-in, rotate, pan etc.). Such rules which may be dependent on:

(a) the tracked object (for example, the speed of travel of the ball, a particular player, etc.),

(b) any untracked objects (for example, the basket or in goal in the case of soccer), or

(c) relative relations of the tracked object(s) and the untracked object(s) (i.e., how close is the ball to a basket or goal, whether a particular player is interacting with the ball).

The invention may further use of a learning mode which allows rules to be refined by subsequent input (either through additional rules, or “reward and punishment” for automatic learning mode). In a live-broadcast mode, rules may be set to mix the outputs of the various different cameras. Including rules which govern possible “instant replays” under certain prescriptions which may be dependent on the tracked objects, the relation of the tracked objects to untracked objects, and external parameters such as time or time-dependent events (such as when the ball hits the basket, the ball is within certain distance of the goal, or when there is a time out).

Rules may also be used to automatically “edit” a production to generate an output which better resembles a human-engineered production. That is, the output 130 in the Figure way switch between the narrow-field (or the narrow-field and wide-field) cameras to achieve a more interesting final product. For example, during periods of relative inactivity the source may automatically switch to a wide-angle (or audience) shot, whereas, during close player contact, a narrow-field camera with the best “view” may automatically be selected.

I claim:

1. Apparatus for automatically video recording an event incorporating a moving target, comprising:
a master video camera having a wide-angle field of view including the target as it moves from place to place during the event;
a slave camera including pan/tilt and zoom capabilities and a field of view narrower than that of the master video camera; and
a programmed computer interfaced to the master camera and to the slave camera, the computer being operative to perform the following functions:
a) determine the position of the target in accordance with the output of the master camera; and
b) cause the slave camera to follow the target and a scene immediately surrounding the target using the pan/tilt and zoom capabilities based upon the output of the master camera.
